(19) United States
(12) Patent Application Publication
(10) Pub. No.: US 2004/0178891 A1
(43) Pub. Date: Sep. 16, 2004

(54) Vehicle security system having remote status indication

(76) Inventor: Lindsay L. Palmer, Covina, CA (US)

Correspondence Address: ROY A. EKSTRAND, STE 150, 3158 REDHILL AVE., COSTA MESA, CA, 92626, US

(21) Appl. No.: 10/389,208

(22) Filed: Mar. 14, 2003

(51) Int. Cl. B60R 25/10

(52) U.S. Cl. 340/426.1

(57) ABSTRACT

A vehicle security system includes a vehicle unit housed within a host vehicle together with a separate remote unit to be carried by the user. The remote unit includes communication capability for issuing commands to the vehicle unit in response to which the desired vehicle security alarm and lock conditions are set within the vehicle. The system further includes the use of a status inquiry input within the remote unit together with operative systems for providing an indication of the vehicle security system status to be available to the remote unit user.

### FIELD OF THE INVENTION

This invention relates generally to vehicle security systems and particularly to those utilizing remote activation/deactivation units.

### BACKGROUND OF THE INVENTION

Vehicle security and alarm systems are well known in the art and have enjoyed substantial increase in popularity over the years. This increase in popularity has reached a point at which a variety of vehicles including virtually every type of commonly used vehicle including but not limited to automobiles, trucks, vans, minivans, sport utility vehicles, campers and/or motor homes are available with a variety of vehicle security systems. The steadily increase in popularity and demand for vehicle security systems together with the substantial advances in related electronic and computer technologies have led to a virtually endless variety of vehicle security systems.

Despite this very substantial variety of vehicle security systems, most vehicle security systems may be generally described as comprising a common collection of interacting based elements. Thus, for example, most vehicle security systems include electrically operated door locks on the vehicle, an alarm apparatus providing both audible and visible light alarm units, signal receivers, together with a processor and controller which is typically microprocessor based. Finally, such typical vehicle security systems also utilize a remote unit which is operated by the user and which communicates with the signal receiver of the vehicle unit using a conventional communication mechanism such as coded radio frequency signals or the like.

The typical operation of such vehicle security systems is also capable of general description despite the substantial variety in security system designs and structures. For the most part, the system is operated in a locking and arming mode when the user is departing the vehicle for a period of time. Conversely, the system is operated in an access and disarming mode when the user returns to the vehicle following a period of alarm activation and security locking. Thus, when the user has parked the vehicle and is intending to leave the vehicle for any length of time, the user exits the vehicle after locking the doors and arming the alarm system. Alternatively, the user may exit the vehicle and utilize the remote unit to provide a coded signal to the processor within the vehicle unit to cause the vehicle to be locked and to cause the alarm system to be armed.

When returning to the vehicle, after having left the vehicle in a secure locked and armed condition, the user typically actuates the remote unit to transmit a coded signal to the processor within the vehicle unit causing the system to disarm the alarm and open the vehicle locks.

In most vehicle security systems, audible and visual indication and confirmation of the security system status is given in response to the act of operating the remote unit. Typically, one or more audible beep tones and/or flashing lights are provided in response to activation of the remote unit. In many systems, the vehicle horn and vehicle lights are operatively connected to the security system and are utilized to provide all or part of the audible and visual light indication of system status change in response to the user manipulation of the remote unit. Thus, as the user departs the vehicle actuating the lock and arm feature of the remote, the vehicle responds immediately with one or more beep tones and light flashes to assure the user that the system is locked and armed. Similarly, when the user approaches the secured vehicle and operates the remote unit to gain access to the system unlocking the vehicle doors and disarming the alarm system, the vehicle again responds immediately to the received signal by producing one or more audible beep tones and/or flashing lights.

For the most part, the presently available vehicle security systems have enjoyed sufficient development and improvement to provide performance and effectiveness which is generally satisfactory. The processor controlled digital electronic vehicle units generally available are easily installed in virtually any vehicle. Conventional door locks of the type previously provided in vehicles and referred to as generally as “power door locks” are easily integrated into the vehicle security system. In addition, due in large part to recent advances in digital electronic technologies, remote units are relatively small and easy to use. In fact, most such remote units have become sufficiently small and compact to be carried as part of the users keychain collection.

Not withstanding the high state of vehicle security system development, there remains nonetheless a continuing need in the art for ever more improved and effective vehicle security systems. One of the most pressing needs for improving vehicle security systems arises in connection with improved systems for communication and confirmation of security system status for the vehicle user.

### SUMMARY OF THE INVENTION

Accordingly, it is a general object of the present invention to provide an improved vehicle security system. It is a more particular object of the present invention to provide an improved vehicle security system having improved remote status indication for the user. It is a still more particular object of the present invention to provide a vehicle security system in which system status may be communicated in alternative communication modes.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a block diagram an improved vehicle security system having remote status indication constructed in accordance with the present invention:

FIG. 2 sets forth a block diagram of an alternate embodiment of the present invention vehicle security system having remote status indication which utilizes a more extended communication link between the remote unit and the vehicle unit;

FIG. 3 sets forth a block diagram of a further alternate embodiment of the present invention improved vehicle security system having remote status indication which utilizes multiple communication links between the vehicle security system unit and the remote unit.

### DESCRIPTION OF THE PREFERRED EMBODIMENTS

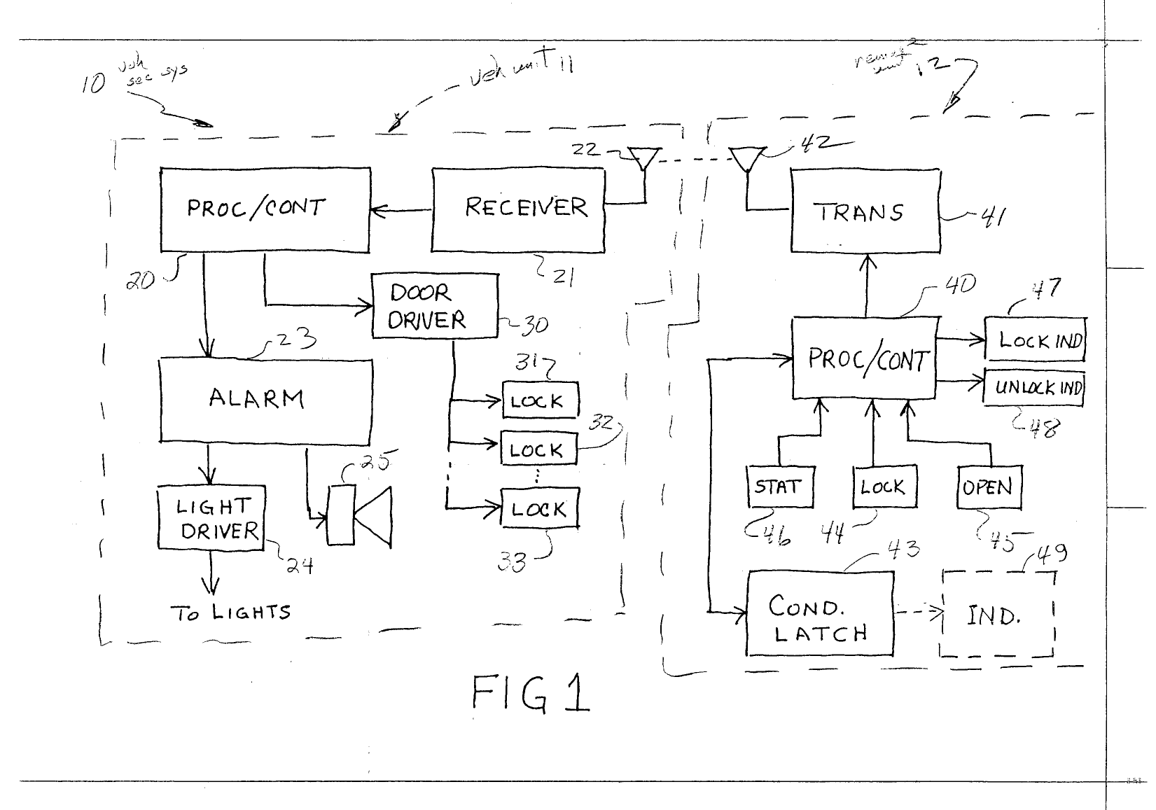

FIG. 1 sets forth a block diagram of a vehicle security system having remote status indication which is constructed in accordance with the present invention and which is generally referenced by numeral 10. In accordance with conventional fabrication techniques, system 10 utilizes a vehicle unit 11 together with a cooperating remote unit 12. As mentioned above, in the background of the invention, a typical vehicle security system utilizes a vehicle unit which is permanently installed within the host vehicle together with a portable or handheld remote unit. System 10 follows this format utilizing a vehicle installed unit 11 and a remote unit 12 which, in its anticipated fabricated, comprises a small battery powered handheld unit.

More specifically, vehicle unit 11 is constructed in accordance with conventional fabrication techniques and utilizes a processor and controller 20 coupled to a radio frequency receiver 21. Receiver 21 is further coupled to an antenna 22. In further accordance with conventional fabrication techniques, vehicle unit 11 includes an alarm system 23 operatively coupled to a light driver circuit 24 and an audio output device 25. A door driver 30 is operated in response to processor and controller 20 and is coupled to a plurality of electrically operated door lock mechanisms 31, 32 and 33. Door lock mechanisms 31 through 33 is shown in FIG. 1 to depict an indefinite number of operative electric door lock mechanisms due to the variation in host vehicles and thereby the variation in the number of door lock mechanisms required. As mentioned above, in the embodiment of the present invention shown in FIG. 1, vehicle unit 11 may be fabricated entirely in accordance with conventional fabrication techniques. Thus, alarm system 23 will be understood to be provided by virtually any of the presently available well known vehicle alarm systems. Similarly, processor and controller 20 will be understood to operate in accordance with conventional fabrication techniques and will typically comprise a microprocessor based controller which responds to signals received from receiver 21 to set the alarm condition of alarm system 23 and the lock condition of locks 31 through 33 using door driver 30.

In accordance with the present invention, remote unit 12 includes a processor and controller 40 operatively coupled to a transmitting unit 41 which is further coupled to an antenna 42. A plurality of user input devices such as pushbuttons are supported upon remote unit 12 and are operatively coupled to processor and controller 40. In the example shown in FIG. 1, a plurality of user operated buttons 44, 45 and 46 are utilized for user inputs to processor and controller 40. Input 44 produces a signal condition which causes processor and controller 40 to receive a lock instruction while input 45 produces a signal condition which causes processor and controller 40 to receive an open condition. User input 46 comprises a status inquiry input device and produces an input condition for processor and controller 40 which causes and processor and controller 40 to respond to a status inquiry.

In accordance with an important aspect of the present invention, remote unit 12 further includes a condition latch circuit 43 together with a pair of status indicators 47 and 48 all operatively coupled to processor and controller 40. Status indicators 47 and 48 may, for example, comprise conventional light emitting diode units supported upon remote unit 12 and selectively illuminated by processor and controller 40 to indicate either a lock condition or unlock condition as desired. Condition latch 43 may include a flag set within processor 40 or a separate latch circuit set to retain and store the lock or unlocked condition status of the vehicle alarm system.

In operation, the user manipulates remote unit 12 to set the alarm condition and lock status within vehicle unit 11 in accordance with conventional operation. Thus, as the user exits the host vehicle, the user simply activates lock input 44 causing processor and controller 40 to utilize transmitter 41 and antenna 42 to produce a coded radio frequency signal which is received by antenna 22 and receiver 21 of vehicle unit 11. In response, processor and controller 20 within vehicle unit 11 arms alarm 23 and energizes door driver 30 to produce activation of door locks 31 through 33. At this point, vehicle unit 11 is in an armed and locked secure configuration.

In accordance with an important aspect of the present invention, processor and controller 40 responds to the lock command input from input 44 to also set the lock condition within condition latch 43. Thereafter, condition latch 43 retains the indication of vehicle unit status as locked and armed. In the event the user desires at some point to confirm the status of vehicle unit 11, the user simply activates status input 46 which causes processor and controller 40 to read the condition of condition latch 43 and illuminate the appropriate one of indicators 47 and 48. In the present example, since the user has armed the alarm system and locked the host vehicle, processor and controller 40 reads a locked and armed condition for latch 43 and illuminates lock indicator 47. In accordance with an important aspect of the present invention, this provides a positive confirmation to the user that the user did indeed remember to lock the vehicle and set the alarm system when the user last exited and departed the vehicle. It will be noted that had the user neglected to set the alarm and lock system of vehicle unit 11 in departing previously, the lock condition within latch 43 would not have been appropriate for confirming a locked and armed configuration. Accordingly, processor and controller 40 would have read the absence of a locked and armed condition with latch 43 and would have illuminated indicator 48 communicating the absence of a locked and armed condition within the vehicle.

Thus, with an important aspect of the present invention, the user is able at any time without further communication to the vehicle and without being in range of the vehicle security system communication capability to nonetheless confirm the status of the vehicle alarm in a simple but effective manner.

In further operation, as the user approaches the vehicle, the user is able to disarm the alarm system and unlock the door locks by simply activating input 45. In response to an input 45 activation, processor and controller 40 sets condition latch 43 to the open and unlocked condition and causes transmitting unit 41 to transmit the appropriate coded signal to vehicle unit 11 further causing processor and controller 20 to disarm alarm 23 and open locks 31 through 33.

Each time that the vehicle system is remotely accessed by the user, the alarm system within the vehicle indicates response to the remotely transmitted signal by emitting one or more audible sounds or “beeps” together with one or more short term flashes of the vehicle lights. Thus, in the normal operation of the vehicle security system using the remote unit, the process is one of sending a command to either lock and secure the system or open and unlock the system while observing the vehicle for an indication of the response to the remotely transmitted command.

As the user operation of system 10 continues, each time the user activates remote unit 12 to lock or open the vehicle, the appropriate condition is stored within latch 43 and is utilized by processor and controller 40 to provide a corresponding indication of the last set alarm and lock condition within the vehicle. The user is able refresh the users memory or confirm status at any time by simply activating status inquiry input 46 in response to which processor and controller 40 will illuminate the appropriate indicator to confirm vehicle security system status.

The embodiment of the present invention shown in FIG. 1, provides a simple low-cost and easily implemented embodiment of the present invention which is capable of providing substantial reassurance to the user or conversely alerting the user to a failure to lock and arm the security system of the vehicle when last departing from it. As a result, the embodiment set forth in FIG. 1 greatly enhances the users security and comfort in traveling away from the vehicle.

Despite the simplicity and low-cost and effectiveness of the embodiment of FIG. 1, it is however somewhat limited in that it operates in a condition which may be generally described as “open loop” in that the status or condition of the security system is set within the remote unit regardless of whether the vehicle unit itself is actually communicated with. Since the normal operation of such vehicle security systems described generally above typically involves the user viewing the vehicle directly and the vehicle system providing audible and visual confirmation of system response, this type of open loop performance is, for the most part, completely satisfactory.

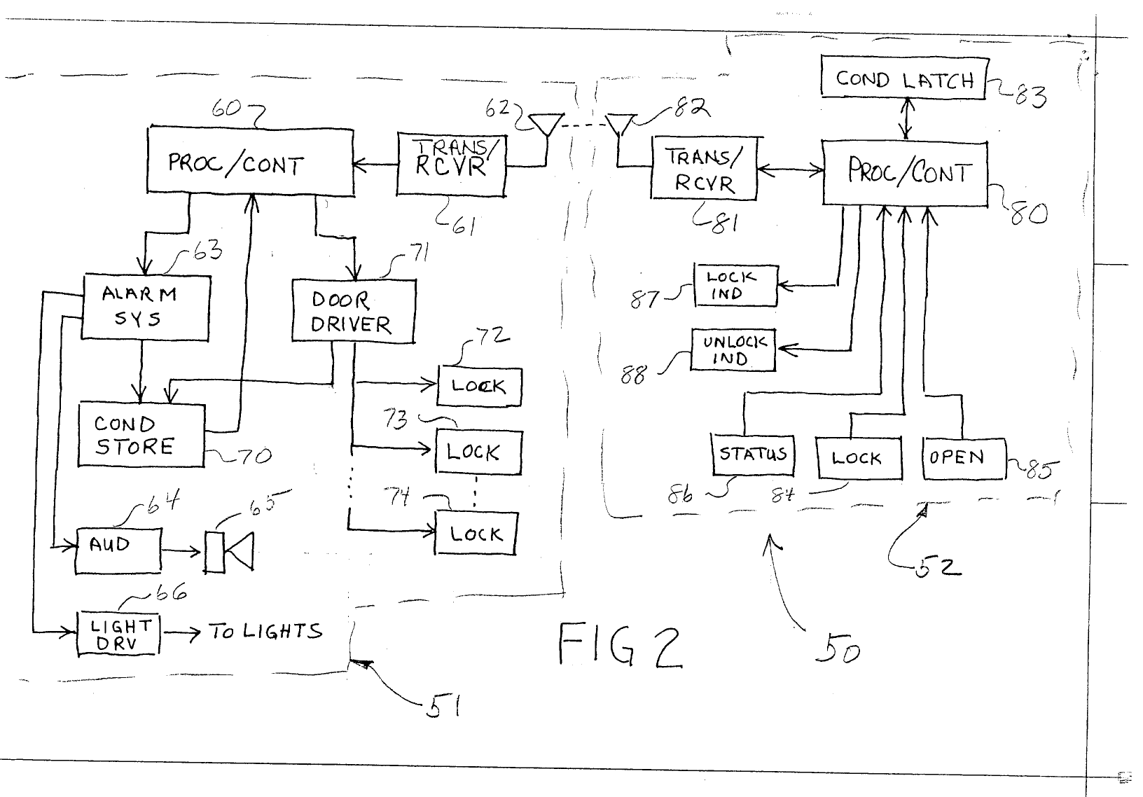

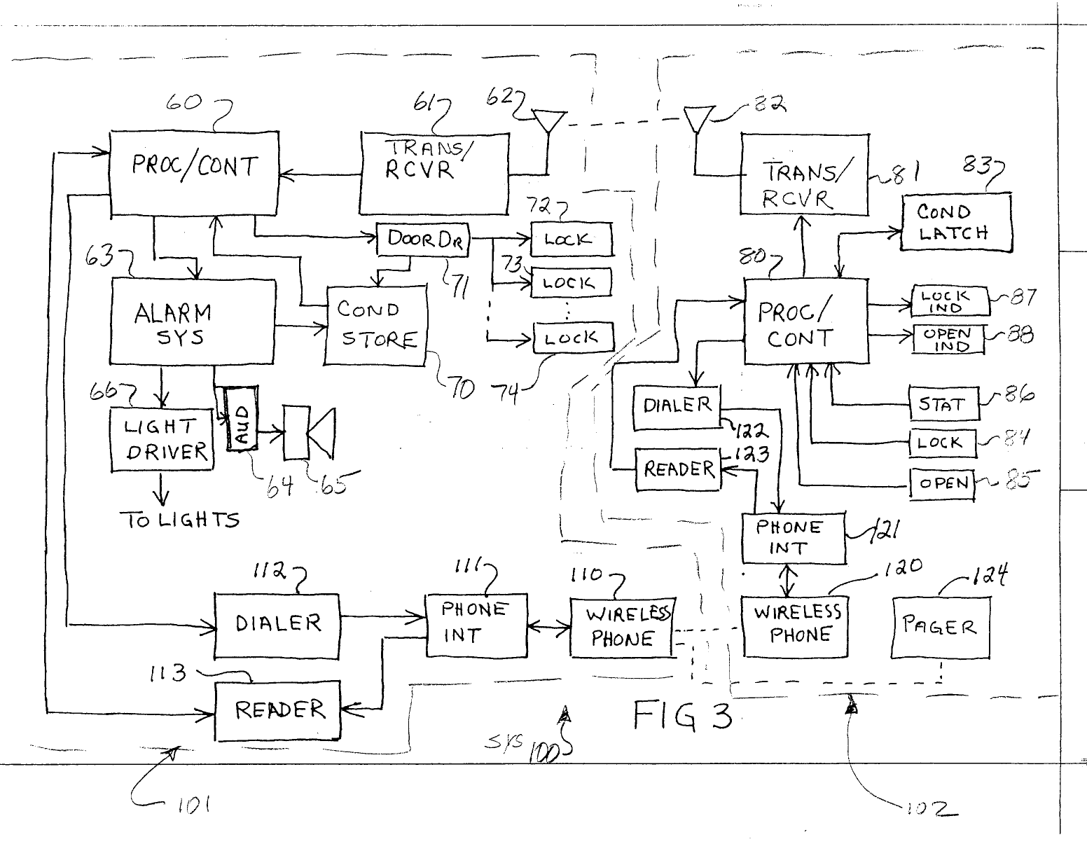

In the event however that a more sophisticated closed loop operation and system is required to provide greater confidence level and greater assurance, the present invention may be implemented and utilized in a closed loop embodiment. Examples of closed loop embodiments of the present invention are set forth below in FIGS. 2 and 3.

In a variation of the system of FIG. 1, the use of status inquiry 46 and lock indicators 47 and 48 may be omitted and replaced by a single indicator 49 (shown in dash line representation) which operates continuously in response to the configuration of latch 43 in an armed and locked condition. In this event, the user is able to determine system configuration by simply observing indicator 49. While a variety of indicators may be used, a simple flashing indicator such as a light emitting diode or the like may be used for indicator 49. Thus, the user would know that flashing of indicator 49 confirms the locked and armed condition of the vehicle security system.

FIG. 2 sets forth an alternate embodiment of the present invention vehicle security system having remote status indication generally referenced by numeral 50. Vehicle security system 50 is a closed loop embodiment of the present invention system in that it includes a vehicle unit 51 operating in combination with a remote unit 50 via a two-way radio frequency transmission capability. In this manner, the vehicle security system assurance and confirmation is provided to the remote unit by a specific communication from the vehicle unit thereby providing enhanced confirmation.

More specifically, vehicle unit 51 includes a processor and controller 60 operatively coupled to a transmitter and receiver 61 which in turn is coupled to an antenna 62. An alarm 63 is operatively coupled to processor and controller 60 and includes an audio driver 64 coupled to an audio output device 65 together with a light driver 66 which is coupled to the vehicle lights (not shown). A door driver 71 is operatively coupled to processor and controller 60 and is further coupled to a plurality of electrically operated door locks 72, 73 and 74. Once again, it will be noted that the number of actual door locks accommodated by door driver 71 is indefinite and is selected in accordance with the configuration of the host vehicle. In accordance with the present invention, vehicle unit 51 further includes a condition storage unit 70 which is operatively coupled to alarm system 63 and door driver 71 and is further coupled to processor and controller 60.

Remote unit 52 includes a processor and controller 80 operatively coupled to a transmitter and receiver 81 which in turn is coupled to an antenna 82. A pair of indicators 87 and 88 are coupled to processor and controller 80. In addition, a trio of user inputs 84, 85 and 86 are supported by remote unit 52 and are coupled to processor and controller 80. Input 84 provides a lock input while input 85 provides an open condition input to processor and controller 80. Status input 86 initiates a status inquiry on the part of processor 80. Toward that end, a condition latch 83 is operatively coupled to processor and controller 80.

In operation, processor and controller 60 responds to signals received by transmitter and receiver 61 to set the alarm status of alarm system 63 and the activation of door driver 71. Thus, in response to the appropriate signal received from remote unit 50 as the user departs the vehicle and secures the vehicle, processor and controller 60 initiates the arming of alarm system 63. Concurrently, processor and controller 60 actuates door driver 71 causing locks 72 through 74 to be operated to a locked condition. With the arming of alarm system 63, audio output device 64 and light driver 66 are actuated to provide a predetermined audible output sound at device 65 together with a brief flashing of one or more of the host vehicle lights. In addition, the arming of alarm system 63 and activation of door driver 71 to a locked condition is communicated to condition storage unit 70. Condition storage unit 70 may comprise a conventional latch circuit or a bistable circuit which provides storage of the status of the vehicle security system. This status is available to processor 60 by accessing condition storage unit 70.

When transmitting and receiving unit 61 receives an open or access command from remote unit 52, processor and controller 60 responds by changing alarm system 63 to an inactive state and by activating door driver 71 to unlock door locks 72 through 74. Once again, the change in system status at alarm system 63 causes the activation of audible sound unit 64 and light driver 66 to provide a predetermined audible tone or tones and a predetermined flashing of the vehicle lights. Concurrently, the change of status of alarm system 63 and door driver 71 causes a corresponding change in the status indicator stored within condition storage unit 70. Once again, the status of condition storage unit 70 is available to processor 60 for use in the manner described below.

The operation of remote unit 52 is carried forward in general correspondence to the above described remote unit in that the user is able to arm the vehicle alarm system and secure the door locks upon departing the vehicle by simply actuating lock command input 84. In response to the lock command input, processor and controller 80 sets the condition of latch 83 to a locked and armed indication and transmits a lock and secure command via transmitter and receiver 81 to vehicle unit 51. Vehicle unit 51 responds as described above. Conversely, as the user approaches the locked and secured vehicle, actuation of command input 85 causes processor 80 to set an open condition in latch 83 and to transmit a suitable command via transmitting and receiving circuit 81 to cause vehicle unit 51 to cycle in the above described manner to disarm alarm system 63 and unlock doors 72 through 74.

In accordance with the present invention, the user activates status input 86 to determine the condition of the vehicle security system whenever desired. Unlike the embodiment set forth above however, the operation of processor and controller 80 in response to a status inquiry initiates and inquiry command which is transmitted by transmitting and receiver circuit 81 to vehicle unit 51. When transmitting and receiving circuit 61 of vehicle unit 51 receives a status inquiry command, processor and controller 60 accesses condition storage unit 70 and determines system status. Thereafter, processor and controller 60 causes transmitting and receiving circuit 61 to communicate to remote unit 52 in a manner confirming the system status. Transmitting and receiving circuit 81 communicates this information to processor and controller 80 which in turn responds by activating the appropriate indicator of indicators 87 and 88.

As a result of this bidirectional communication, the response to a status inquiry initiated by the user at remote unit 50 includes a communication to vehicle unit 51 and a confirming response from the vehicle unit. This provides a closed loop operation and a greater level of assurance and reliability. This operation is initiated so long as remote unit 52 is within appropriate communication range for radio frequency communication to vehicle unit 51.

In the event remote unit 52 is out of communication range with vehicle unit 51, the system responds in the manner of the embodiment set forth above in FIG. 1 in that processor and controller 80 then accesses the previously set most recent condition within condition latch 83. In response to this condition status, processor 80 then activates the appropriate one of indicators 87 or 88. In this manner, the system compensates for an out of range condition by reverting to an open loop operation.

FIG. 3 sets forth a block diagram of a still further sophisticated embodiment of the present invention vehicle security system having remote status indication generally referenced by numeral 100. System 100 includes a vehicle unit 101 together with a remote unit 102. By way of overview, it will be apparent to those skilled in the art that system 100 includes the system elements set forth above in FIG. 2 for vehicle security system 50 together with additional apparatus having wireless phone and pager communication capability. Thus, system 100 provides even greater flexibility and operational capability together with greater levels of system status confirmation.

More specifically, vehicle unit 101 includes a processor and controller 60 operatively coupled to a transmitter and receiver 61 which in turn is coupled to an antenna 62. An alarm 63 is operatively coupled to processor and controller 60 and includes an audio driver 64 coupled to an audio output device 65 together with a light driver 66 which is coupled to the vehicle lights (not shown). A door driver 71 is operatively coupled to processor and controller 60 and is further coupled to a plurality of electrically operated door locks 72, 73 and 74. Once again, it will be noted that the number of actual door locks accommodated by door driver 71 is indefinite and is selected in accordance with the configuration of the host vehicle. In accordance with the present invention, vehicle unit 101 further includes a condition storage unit 70 which is operatively coupled to alarm system 63 and door driver 71 and is further coupled to processor and controller 60.

Remote unit 102 includes a processor and controller 80 operatively coupled to a transmitter and receiver 81 which in turn is coupled to an antenna 82. A pair of indicators 87 and 88 are coupled to processor and controller 80. In addition, a trio of user inputs 84, 85 and 86 are supported by remote unit 102 and are coupled to processor and controller 80. Input 84 provides a lock input while input 85 provides an open condition input to processor and controller 80. Status input 86 initiates a status inquiry on the part of processor 80. Toward that end, a condition latch 83 is operatively coupled to processor and controller 80.

In operation, processor and controller 60 responds to signals received by transmitter and receiver 61 to set the alarm status of alarm system 63 and the activation of door driver 71. Thus, in response to the appropriate signal received from remote unit 100 as the user departs the vehicle and secures the vehicle, processor and controller 60 initiates the arming of alarm system 63. Concurrently, processor and controller 60 actuates door driver 71 causing locks 72 through 74 to be operated to a locked condition. With the arming of alarm system 63, audio output device 64 and light driver 66 are actuated to provide a predetermined audible output sound at device 65 together with a brief flashing of one or more of the host vehicle lights. In addition, the arming of alarm system 63 and activation of door driver 71 to a locked condition is communicated to condition storage unit 70. Condition storage unit 70 may comprise a conventional latch circuit or a bistable circuit which provides storage of the status of the vehicle security system. This status is available to processor 60 by accessing condition storage unit 70.

When transmitting and receiving unit 61 receives an open or access command from remote unit 102, processor and controller 60 responds by changing alarm system 63 to an inactive state and by activating door driver 71 to unlock door locks 72 through 74. Once again, the change in system status at alarm system 63 causes the activation of audible sound unit 64 and light driver 66 to provide a predetermined audible tone or tones and a predetermined flashing of the vehicle lights. Concurrently, the change of status of alarm system 63 and door driver 71 causes a corresponding change in the status indicator stored within condition storage unit 70. Once again, the status of condition storage unit 70 is available to processor 60 for use in the manner described below.

The operation of remote unit 102 is carried forward in general correspondence to the above described remote unit in that the user is able to arm the vehicle alarm system and secure the door locks upon departing the vehicle by simply actuating lock command input 84. In response to the lock command input, processor and controller 80 sets the condition of latch 83 to a locked and armed indication and transmits a lock and secure command via transmitter and receiver 81 to vehicle unit 101. Vehicle unit 101 responds as described above. Conversely, as the user approaches the locked and secured vehicle, actuation of command input 85 causes processor 80 to set an open condition in latch 83 and to transmit a suitable command via transmitting and receiving circuit 81 to cause vehicle unit 101 to cycle in the above described manner to disarm alarm system 63 and unlock doors 72 through 74.

In accordance with the present invention, the user activates status input 86 to determine the condition of the vehicle security system whenever desired. Unlike the embodiment set forth above however, the operation of processor and controller 80 in response to a status inquiry initiates and inquiry command which is transmitted by transmitting and receiver circuit 81 to vehicle unit 101. When transmitting and receiving circuit 61 of vehicle unit 101 receives a status inquiry command, processor and controller 60 accesses condition storage unit 70 and determines system status. Thereafter, processor and controller 60 causes transmitting and receiving circuit 61 to communicate to remote unit 102 in a manner confirming the system status. Transmitting and receiving circuit 81 communicates this information to processor and controller 80 which in turn responds by activating the appropriate indicator of indicators 87 and 88.

As a result of this bidirectional communication, the response to a status inquiry initiated by the user at remote unit 100 includes a communication to vehicle unit 101 and a confirming response from the vehicle unit. This provides a closed loop operation and a greater level of assurance and reliability. This operation is initiated so long as remote unit 102 is within appropriate communication range for radio frequency communication to vehicle unit 101.

In the event that remote unit 102 is beyond radio frequency communication range with vehicle unit 101, processor and controller 80 utilizes a wireless communication link capability between remote unit 102 and vehicle unit 101. Accordingly, remote unit 102 further includes a telephone dialer 122 coupled to a phone interface 121. Interface 121 is further coupled to a wireless telephone 120. In addition, a phone reader 123 is operatively coupled to phone interface 121 and processor 80. Further a pager 124 is available to the user for operation in the manner described below.

Correspondingly, vehicle unit 101 includes a wireless phone 110 coupled to a phone interface 111. Interface 111 is coupled to a telephone dialer 112 and a telephone dial reader 113. Dialer 112 and reader 113 are operatively coupled to processor and controller 60.

In operation, once the user has initiated the above described status inquiry by operating status input 86, and processor and controller 80 has been unsuccessful in communicating with vehicle unit 101 using the radio frequency communication link between transmitting and receiving circuit 81 of remote unit 102 and transmitting and receiving circuit 61 of vehicle unit 101, processor and controller 80 then initiates a status inquiry utilizing the wireless communication link. In this process, processor and controller 80 accesses telephone dialer 122 and produces the appropriate coded signal to cause phone interface 121 and wireless phone 120 to initiate a wireless call to wireless phone 110 of vehicle unit 101. This call is communicated between wireless phone 120 and 110 in accordance with conventional wireless telephone techniques. In response to a received call, and the establishment of a wireless telephone link between phones 120 and 110, processor and controller 80 then outputs an inquiry code via dialer 122 and phone interface 121 which is communicated by wireless phone 120 to wireless phone 110. Phone interface 111 of vehicle unit 101 then communicates the inquiry signal to processor and controller 60 via telephone reader 113. Thereafter, processor and controller 60 accesses condition storage circuit 70 and communicates the stored condition to telephone dialer 112 in the form of a coded communication. This coded communication is applied to phone interface 111 and wireless phone 110 causing the wireless communication of the status indicative signal to wireless phone 120 of remote unit 102. The status indicative signal is then read by telephone reader 123 which communicates with processor and controller 80. In response to the received status signal, processor and controller 80 then activates the appropriate one of indicators 87 or 88.

Alternatively, processor and controller 60 of vehicle unit 101 may simultaneously or independently provide wireless telephone communication directly to a user pager 124. Such communication may include a simple coded response which may be read by user at pager 124 to determine the status of the vehicle security system.

As a final condition of operation, system 100 may if unable to communicate via the radio frequency link or the wireless telephone link exercise a default condition of operation in which processor and controller 80 responds to status inquiry by the user through accessing condition latch 83 for the last known condition of the vehicle alarm system and provide suitable activation of indicator 87 or 88.

Thus, the embodiment of FIG. 3 provides a plurality of alternative communication usages in response to the circumstances under which remote unit 102 is being utilized with respect to the location of vehicle unit 101 and the host vehicle. This multiple communication link operation provides a maximum of security and reliability for the condition status indication of the vehicle security system to be available upon status inquiry to the vehicle user.

What has been shown is a novel vehicle security system having remote status indication which allows the vehicle user to easily confirm the status of the vehicle security system. The various embodiments shown provide varying levels of system reliability and confidence of status indication.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A vehicle security system for use in a host vehicle, said vehicle security system comprising:
a vehicle unit having an alarm system defining an armed condition and an unarmed condition and a door lock system defining a locked condition and an unlocked condition;
a remote unit having user actuateable inputs for lock, unlock and status inquiry together with a status indicator; and
communication means between said vehicle unit and said remote unit,
said remote unit responding to actuation of said status inquiry input to activate said status indicator to indicate whether said alarm system is armed and whether said door lock system is locked.

2. The vehicle security system set forth in claim 1 wherein said status indicator includes a lock indicator and an open indicator.

3. The vehicle security system set forth in claim 2 wherein said remote unit responds to said lock input by communicating a lock instruction to said vehicle unit and said vehicle unit responds thereto by setting said alarm system to said armed condition and said door lock system to said locked condition.

4. The vehicle security system set forth in claim 3 wherein said remote unit includes a condition latch responsive to user actuation of said lock input to store a lock condition for said status indicator and responsive to user actuation of said unlock input to store an unlock condition for said status indicator.

5. The vehicle security system set forth in claim 4 wherein said status indicator responds to user actuation of said status inquiry input to indicate the most recent user actuation of said lock or unlock inputs.

6. The vehicle security system set forth in claim 3 wherein said remote unit responds to user actuation of said status inquiry input to communicate with said vehicle unit via said communication means to determine the status of said alarm system and said door lock system and to indicate the current conditions thereof on said status indicator.

7. The vehicle security system set forth in claim 6 wherein said communication means includes a remote unit radio frequency transmitting and receiving unit and a cooperating vehicle unit radio frequency transmitting and receiving unit.

8. The vehicle security system set forth in claim 6 wherein said communication means includes a remote unit wireless phone and a vehicle unit wireless phone and wherein said remote unit and said vehicle unit each include telephone interface and telephone dialer means for establishing communication between said vehicle unit wireless phone and said remote unit wireless phone.

9. A vehicle security system comprising:
a processor having a stored instruction set;
signal receiving means coupled to said processor for receiving remotely controlled transmitted control signals;
an alarm responsive to said processor;
lock means responsive to said controller;
a remote signal transmitter carried by a vehicle user and having means for producing lock signals and open signals to said receiver; and
status indication means for providing an indication current vehicle security system.

10. The vehicle security system set forth in claim 4 wherein said remote signal transmitter includes user operable lock and unlock inputs and wherein said status indication means includes a condition latch responsive to user operation of said lock and unlock inputs and a condition indicator responsive to said condition latch.

11. A vehicle security system for use in a host vehicle, said vehicle security system comprising:
a vehicle unit having an alarm system defining an armed condition and an unarmed condition and a door lock system defining a locked condition and an unlocked condition, said vehicle unit establishing a first condition in which said alarm system and said door lock systems define said armed and locked conditions respectively and a second condition in which said alarm system and said door lock system define said unarmed and unlocked conditions respectively;
a remote unit having user actuateable inputs for said first and second conditions together with a status indicator;
communication means between said vehicle unit and said remote unit for establishing said first and second conditions; and
a status indicator on said remote unit operative to indicate whether said vehicle unit is in said first condition or said second condition.

12. The vehicle security system set forth in claim 11 wherein said status indicator is continuously active.

13. The vehicle security system set forth in claim 11 wherein said status indicator is periodically active.

14. The vehicle security system set forth in claim 11 wherein said remote unit includes a user actuateable status inquiry input and wherein said status indicator is active solely in response to user actuation of said status inquiry input.
